(19) United States
(12) Patent Application Publication
(10) Pub. No.: US 2017/0289159 A1
(43) Pub. Date: Oct. 5, 2017

(54) SECURITY SUPPORT FOR FREE WI-FI AND SPONSORED CONNECTIVITY FOR PAID WI-FI

(71) Applicant: Intel IP Corporation, Santa Clara, CA (US)

(72) Inventors: Farid Adrangi, Lake Oswego, OR (US); Jasmeet Chhabra, Hillsboro, OR (US)

(21) Appl. No.: 15/087,619

(22) Filed: Mar. 31, 2016

(51) Int. Cl. H04L 29/06; H04W 12/08

(52) U.S. Cl. CPC H04L 63/10; H04W 12/08; H04L 63/02; H04L 63/08; H04W 84/12

(57) ABSTRACT

Methods and apparatus to support secure Wi-Fi AP protocols are disclosed. An example method includes in response to receiving a request from a computing device to connect to a network, limiting, with a processor of a Wi-Fi access point, access of the computing device to the network to connect to a server; authenticating, with the processor of the Wi-Fi access point, the computing device based on data received from the server; and expanding, with the processor of the Wi-Fi access point, the access of the computing device to connect to the network.

### FIELD OF THE DISCLOSURE

This disclosure relates generally to wireless fidelity connectivity (Wi-Fi) and, more particularly, to methods and apparatus to support security for free Wi-Fi and sponsor connectivity for paid Wi-Fi.

### BACKGROUND

Many locations provide Wi-Fi to connect Wi-Fi enabled devices to networks such as the Internet. Wi-Fi enabled devices include personal computers, video-game consoles, mobile phones and devices, digital cameras, tablets, digital audio players, etc. Wi-Fi allows the Wi-Fi enabled devices to wirelessly access the Internet via a wireless local area network (WLAN). To provide Wi-Fi connectivity to a device, a Wi-Fi access point transmits a radio frequency Wi-Fi signal to the Wi-Fi enabled device within the Wi-Fi signal's range (e.g., a hotspot). Networks including Wi-Fi capability are subject to security breaches. For example, and intruder may try to intercept a Wi-Fi signal to determine information related to a Wi-Fi enabled device.

### BRIEF DESCRIPTION OF THE DRAWINGS

FIG. 1 is an example illustration of a system to facilitate secure Wi-Fi connections between an example client device and an example Wi-Fi Access Point.

FIG. 2 is a diagram representative of example communication between the example client device, the example Wi-Fi Access Point, and the example database proprietor of FIG. 1.

FIG. 3 is a diagram representative of example communication between the example client device, the example Wi-Fi Access Point, and the example enhanced privacy identity verifier server of FIG. 1.

FIG. 4 is a block diagram of the example secure Access Point determiner of FIG. 1.

FIG. 5 is a block diagram of the example access granter of FIG. 1.

FIG. 6 is a block diagram of the example device authenticator of FIG. 1.

FIG. 7 is a flowchart representative of example machine readable instructions that may be executed to implement the secure Access Point determiner of FIG. 1.

FIGS. 8A and 8B are flowcharts representative of example machine readable instructions that may be executed to implement the example access granter of FIG. 1.

FIG. 9 is a flowchart representative of example machine readable instructions that may be executed to implement the example device authenticator of FIG. 1.

FIG. 10 is a block diagram of a processor platform structured to execute the example machine readable instructions of FIG. 7 to implement the example secure Access Point determiner of FIG. 4.

FIG. 11 is a block diagram of a processor platform structured to execute the example machine readable instructions of FIG. 8 to implement the example access granter of FIG. 5.

FIG. 12 is a block diagram of a processor platform structured to execute the example machine readable instructions of FIG. 9 to implement the example device authenticator of FIG. 6.

The figures are not to scale. Wherever possible, the same reference numbers will be used throughout the drawing(s) and accompanying written description to refer to the same or like parts.

### DETAILED DESCRIPTION

Various public locations (e.g., coffee shops, restaurants, parks, airports, etc.) may provide free and/or sponsored Wi-Fi to the public for connecting to the Internet with minimal hassle. The locations may provide one or more Wi-Fi Access Points (APs) to output Wi-Fi signals to any Wi-Fi enabled device within a range of the Wi-Fi signals (e.g., hotspot). A Wi-Fi AP is structured to wirelessly connect a Wi-Fi enabled device to the Internet through a wireless local area network (WLAN). In some examples, a Wi-Fi AP (e.g., an open Wi-Fi AP) may transmit an advertisement (e.g., an open service set identifier (SSID)) for a Wi-Fi connection to the Internet to all Wi-Fi enabled devices within a range of the Wi-Fi AP. In such an example, a user of a Wi-Fi enabled device can select the advertisement of the Wi-Fi enabled device to access the Internet by securing a connection to the Wi-Fi AP. A connection between a Wi-Fi enabled device and a Wi-Fi AP is called a link.

In some examples, the Wi-Fi AP may allow a Wi-Fi enabled device to connect to the Internet without transmitting an advertisement using a hidden SSID. In such an example, a user of a Wi-Fi enabled device may enter the hidden SSID into the Wi-Fi enabled device to access the Internet by securing a link to the Wi-Fi AP.

Three things are needed to create a secure Wi-Fi connection: (A) the Wi-Fi AP must authenticate the Wi-Fi enabled device, (B) the link between the Wi-Fi enabled device and the Wi-Fi AP must been encrypted, and (C) the link must be confidential. The Wi-Fi AP authenticates the Wi-Fi enabled device to make sure that the Wi-Fi enabled device is an actual device and not a virtual station attempting to attack the Wi-Fi AP. Encrypting the link with an encryption key (e.g., a pre-shared key (PSK) or pairwise master key (PMK)) provides protection against an attacker ease dropping on the user's Internet activity while connected. For a link to be confidential, an encryption key must be chosen at random and must not be known by an attacker.

Wi-Fi connections may lack sufficient encryption, authentication, and/or confidentiality. Thus, Wi-Fi connections are susceptible to various security risks. In examples including insufficient authentication, an attacker may run a denial-of-service (DoS) attack to connect a large number of virtual stations to a Wi-Fi AP, thereby exhausting the resources of the Wi-Fi AP. The DoS may significantly slow the connections of all other devices connected to the Wi-Fi AP or may shut down the Wi-Fi AP completely. In examples including insufficient encryption and/or confidentiality, Wi-Fi connections are susceptible to a man-in-the middle attack. A man-in-the middle attack is when an attack secretly relays and/or alters communication between two devices. The man-in-the-middle attack allows an attacker to access user browser data by eavesdropping into the user's connection.

A first conventional technique to provide a secure Wi-Fi connection includes using the SSID output by the Wi-Fi AP as a key (e.g., PSK) to establish a link between a Wi-Fi enabled device and the Wi-Fi AP. However, the SSID is used to advertise to Wi-Fi enabled devices, and, thus, the PSK is publically known. A publically known PSK provides, at best, weak encryption. Additionally, there is no authentication included in using the SSID as the PSK.

A second conventional technique to provide a more secure Wi-Fi connection includes utilizing a Diffie-Hellman technique to generate a shared secret that is used as a key (e.g., PMK) to establish a link between the Wi-Fi enabled device and the Wi-Fi AP. A Diffie-Hellman key exchange includes establishing a secret key over an insecure channel. Although, the Diffie-Hellman key exchange is a stronger encryption than the first conventional technique, the Diffie-Hellman key exchange does not authenticate the Wi-Fi enabled device. Thus, the Diffie-Hellman key exchange is still subject to DoS attacks.

Examples disclosed herein establish a secure Wi-Fi connection for Wi-Fi enabled devices via a Wi-Fi AP by authenticating the Wi-Fi enabled device using data from a database proprietor. Database proprietors operate on the Internet and provide services to large numbers of subscribers. In exchange for the provision of services, the subscribers register with the database proprietors. Examples of such database proprietors include social network sites (e.g., Facebook, Twitter, MySpace, etc.), multi-service sites (e.g., Yahoo!, Google, Axiom, Catalina, etc.), online retailer sites (e.g., Amazon.com, Buy.com, etc.), credit reporting sites (e.g., Experian), streaming media sites (e.g., YouTube, etc.), etc. Database proprietors can verify (e.g., authenticate) a user based on a user ID and password generated during registration.

Examples disclosed herein establish a secure Wi-Fi connection for Wi-Fi enabled devices via a Wi-Fi AP by authenticating the Wi-Fi enabled device using data from an enhanced privacy identity (EPID) verifier server. In one example, an EPID is a digital signature algorithm that may be incorporated into a computing system or integrated circuit chip. The EPID provides a common group public verification key corresponding to a larger number of unique private signature keys. The EPID allows an external party (e.g., a Wi-Fi AP) to authenticate a device associated with the EPID (e.g., a Wi-Fi enabled mobile device) without directly identifying the device. An EPID verifier server stores public verification keys. When an EPID verifier server receives private signature from a Wi-Fi enabled device, the EPID verifier server can authenticate the key using a public verification key without identifying the Wi-Fi enabled device.

Examples disclosed herein provide an encrypted and confidential connection (e.g., link) between an authenticated Wi-Fi enabled device and a Wi-Fi AP. Using examples disclosed herein, a Wi-Fi AP advertises an open SSID to Wi-Fi enabled devices (e.g., client devices). When a client device connects to the Wi-Fi AP via the open SSID, a firewall of the Wi-Fi AP only allows the device to connect to one or more database proprietors and/or an EPID verifier server. When the firewall allows the device to connect to one or more database proprietors, the Wi-Fi AP transmits a prompt to the device that allows the user to choose a database provider to request authorization. For example, the prompt may include a list of database proprietors (e.g., Google, Facebook, Yahoo, etc.) into which a user can log. In some examples, the user credentials associated with the database proprietor may be locally stored on the client device (e.g., with the form of a cookie). In such examples, the client device may automatically log into a database proprietor when a user selects the database proprietor through the prompt.

Once the user logs into the database proprietor, the client device requests authorization with the database proprietor by requesting a unique access token. In some examples, the database proprietor will grant a random access token to the client device and the client device will forward the access token to the Wi-Fi AP. In such examples, the Wi-Fi AP will communicate with the database proprietor to verify that the access token is valid. In some examples, the database proprietor will grant the access token to the Wi-Fi AP along with an ID (e.g., media access control (MAC) address) corresponding to the client device. In such examples, the Wi-Fi AP will grant access to the client device based on the access token and the ID. In general, the Wi-Fi AP authenticates the client device based on shared data received from the client device and the database proprietor.

Once the Wi-Fi AP authenticates the client device, the firewall of the Wi-Fi AP allows the client device total access to the Internet. In some examples, the Wi-Fi AP may open a hidden SSID with full and secure access to a network using a PMK based on a random access token. The PMK is random and not known by any other user, thereby preserving confidentiality. In such examples, the client device may connect to Wi-Fi AP via the hidden SSID using the PMK.

When the firewall allows the device to connect to the EPID verifier server, the client device initiates an EPID-based Sigma key exchange. A Sigma key exchange is a key exchange protocol used to establish secret shared keys for use of a network. The Sigma key exchange prevents man-in-the-middle attacks. Once the Sigma key exchange is established between the client device and the EPID verifier server, the client device sends a MAC address associated with the client device and a request for a hidden SSID with credentials.

In response to receiving the MAC address and request, the EPID verifier server authenticates the client device based on the signature of the device and sends a request to allow full Internet access to the Wi-Fi AP. In some examples, the EPID verifier server also transmits the MAC address of the client device, a hidden SSID, and/or a unique PMK for the device to the Wi-Fi AP. The EPID verifier server further transmits the hidden SSID and the unique PMK to the client device. Once the Wi-Fi AP creates the hidden SSID connection, the client device uses the unique PMK and the hidden SSID to connect to the Wi-Fi AP for encrypted access to the Internet. Such an example preserves confidentiality because the PMK is randomly selected (e.g., unique) and not known by any other user. In general, the Wi-Fi AP authenticates the client device based on shared data received from the client device and the EPID verifier server.

Examples disclosed herein provide sponsored Wi-Fi connectivity to database proprietor and/or EPID device users for paid Wi-Fi networks. For example, if a database proprietor and/or EPID device manufacturer has a relationship with a paid Wi-Fi network, the database proprietor and/or EPID device manufacturer may allow database proprietor/EPID device users to access paid Wi-Fi APs associated with the Wi-Fi network for free by logging into the database proprietor and/or EPID verifier server. In such an example, the paid Wi-Fi networks can credit the database proprietor and/or EPID device manufacturer when a user has logged into the database proprietor while establishing the connection to the Wi-Fi AP.

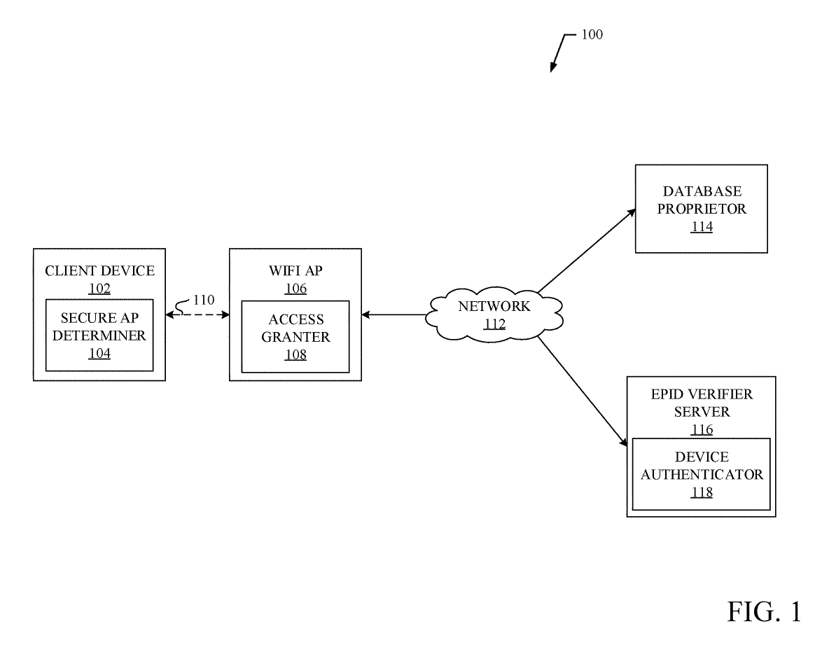

FIG. 1 is an example environment 100 including an example client device 102, an example secure AP determiner 104, an example Wi-Fi AP 106, an example access granter 108, an example communications link 110, an example network 112, an example database proprietor 114, an example EPID verifier server 116, and an example device authenticator 118. FIG. 1 is the example environment 100 illustrating the example client device 102 accessing the example network 112 via the example Wi-Fi AP 106.

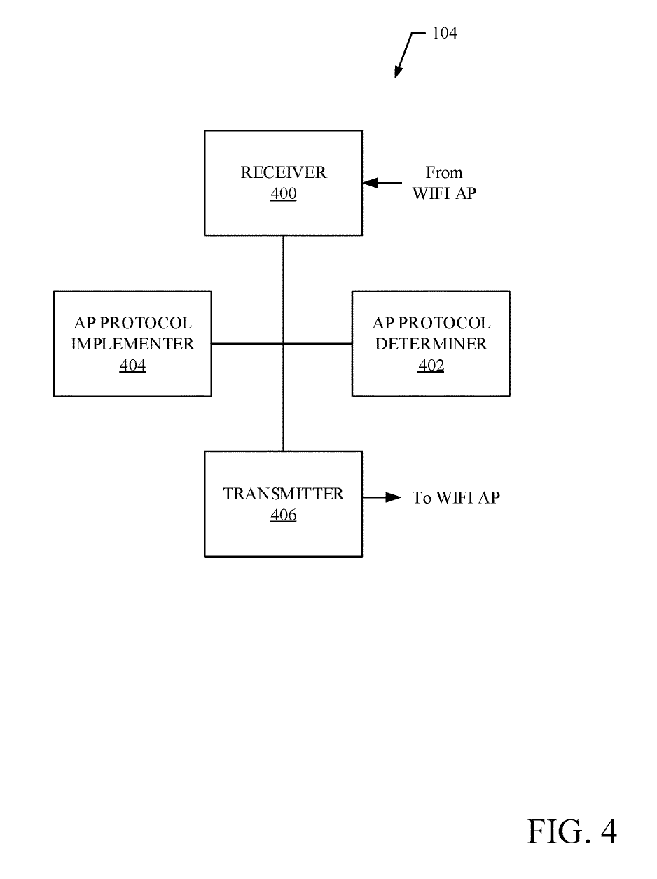

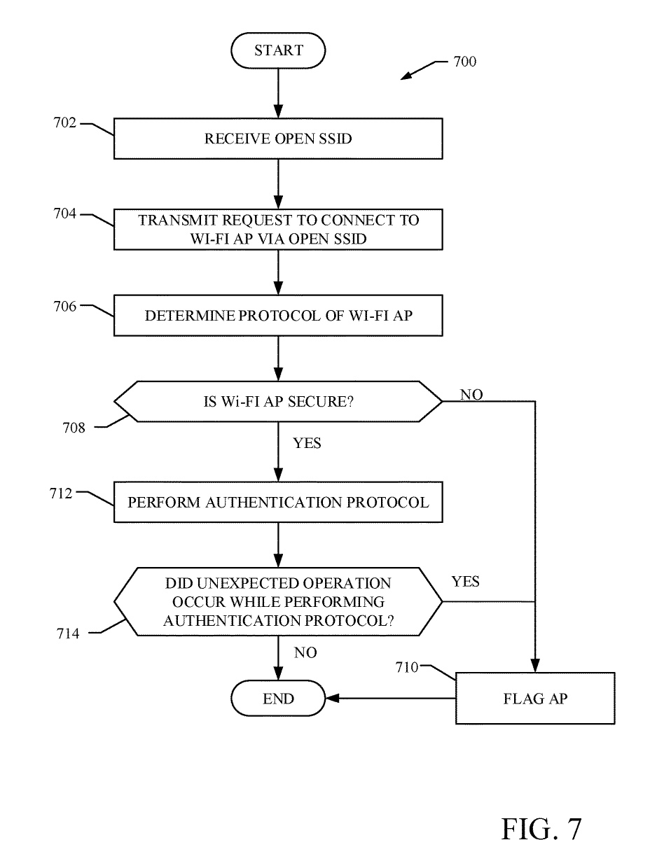

The example client device 102 is a Wi-Fi enabled computing device. The example client device 102 may be, for example, a computing device, a portable device, a mobile device, a mobile telephone, a smart phone, a tablet, a gaming system, a digital camera, a digital video recorder, a television, a set top box, an e-book reader, and/or any other Wi-Fi enabled device. The example client device 102 includes a secure AP determiner 104 to search for and/or connect with an open SSID of a Wi-Fi AP (e.g., the example Wi-Fi AP 106) to access a network (e.g., the example network 112). In some examples, the secure AP determiner 104 connects with a hidden SSID to access a network. As further described in FIGS. 4 and 7, the secure AP determiner 104 may determine whether the example Wi-Fi AP 106 is a rogue AP based on a protocol run by the example AP determiner 104. A rogue AP is an unauthorized AP that may be added by an attacker (e.g. hacker to intercept data related to the example client device 102.

The example Wi-Fi AP 106 is a device that allows the example client device 102 to access wirelessly the example network 112. The example Wi-Fi AP 106 may be a router, a modem-router, and/or any other device that provides a wireless connection to a network. A router provides a wireless communication link (e.g., the example communication link 110) to a client device. The router accesses the network through a wire connection via a modem. A modem-router combines the functionalities of the modem and the router. The example Wi-Fi AP 106 includes a firewall to open and/or close communications with the example network 112.

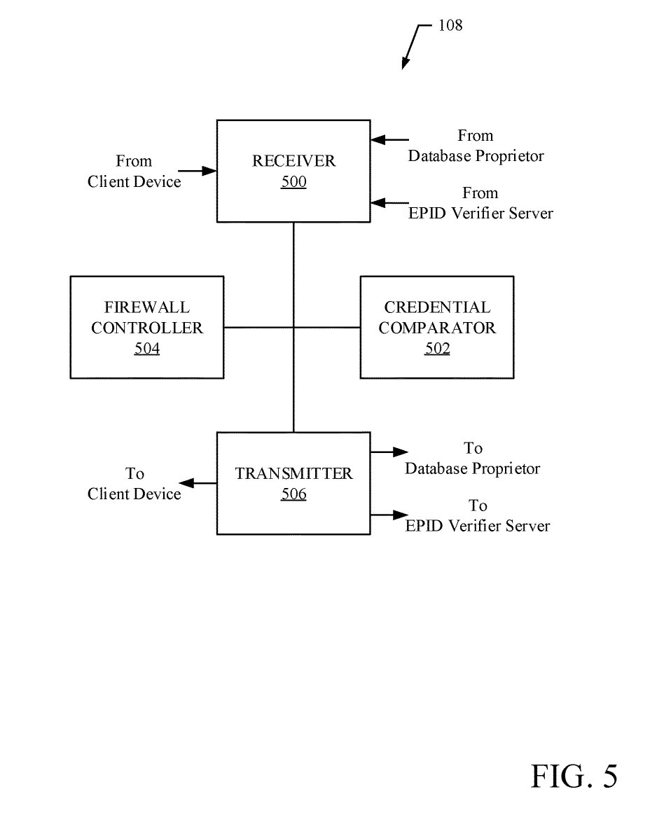

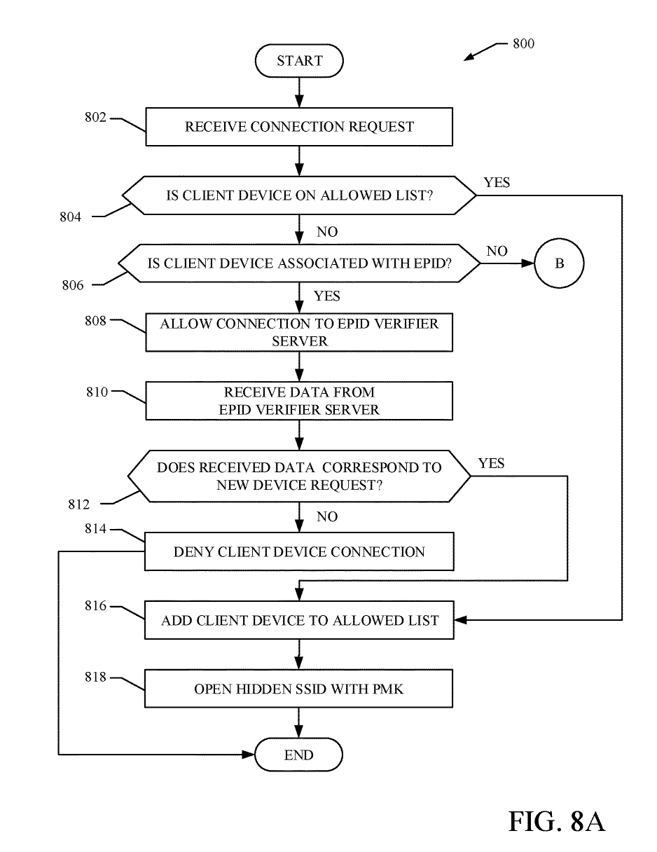

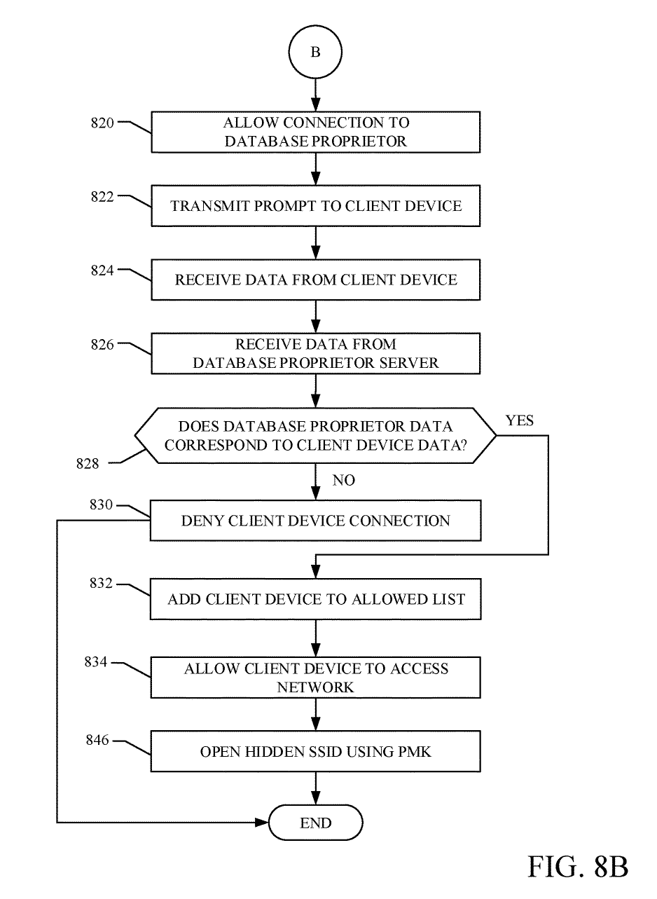

The example Wi-Fi AP 106 further includes the example access granter 108. The access granter 108 grants access of the example client device 102 to the example network 112 via the example communications link 100 once the client device 102 has been authenticated by the database proprietor 114 and/or the example EPID verifier server 116, as further described in FIGS. 5, 8A, and 8B.

The example network 112 is a system of interconnected systems exchanging data. The example network 112 may be implemented using any type of public or private network such as, but not limited to, the Internet, a telephone network, a local area network (LAN), a cable network, and/or a wireless network. To enable communication via the network 112, the example Wi-Fi AP 106 includes a communication interface that enables a connection to an Ethernet, a digital subscriber line (DSL), a telephone line, a coaxial cable, or any wireless connection, etc.

The example database proprietor 114 authenticates a user of the example client device 102 based on user registration records. The example database proprietor 114 may be one of many database proprietors that operate on the Internet to provide services to subscribers. Such services may be email services, social networking services, news media services, cloud storage services, streaming music services, streaming video services, online retail shopping services, credit monitoring services, etc. Example database proprietors include social network sites (e.g., Facebook, Twitter, MySpace, etc.), multi-service sites (e.g., Yahoo!, Google, Axiom, Catalina, etc.), online retailer sites (e.g., Amazon.com, Buy.com, etc.), credit reporting sites (e.g., Experian), streaming media sites (e.g., YouTube, etc.), and/or any other site that maintains user registration records. In some examples, the database proprietor 114 includes a database of profiles (e.g., database proprietor accounts) and a server to access the profiles.

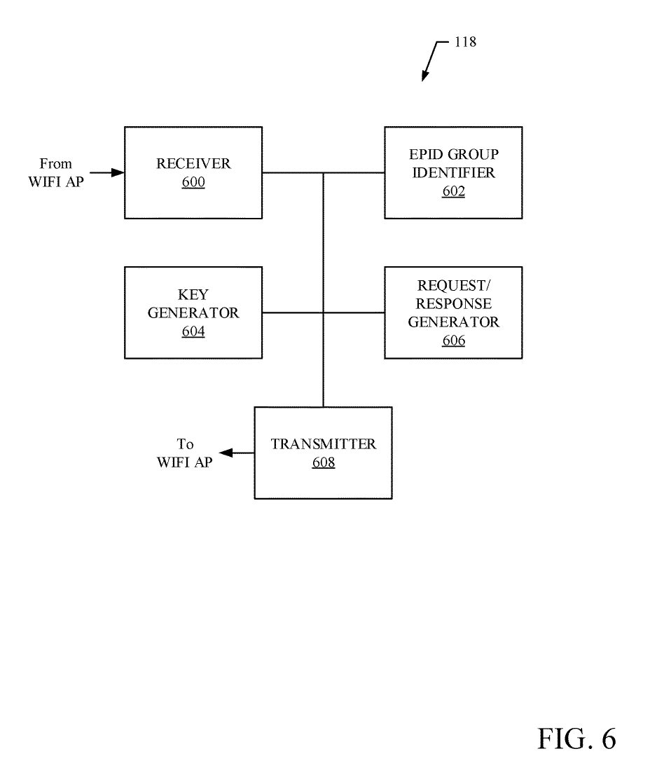

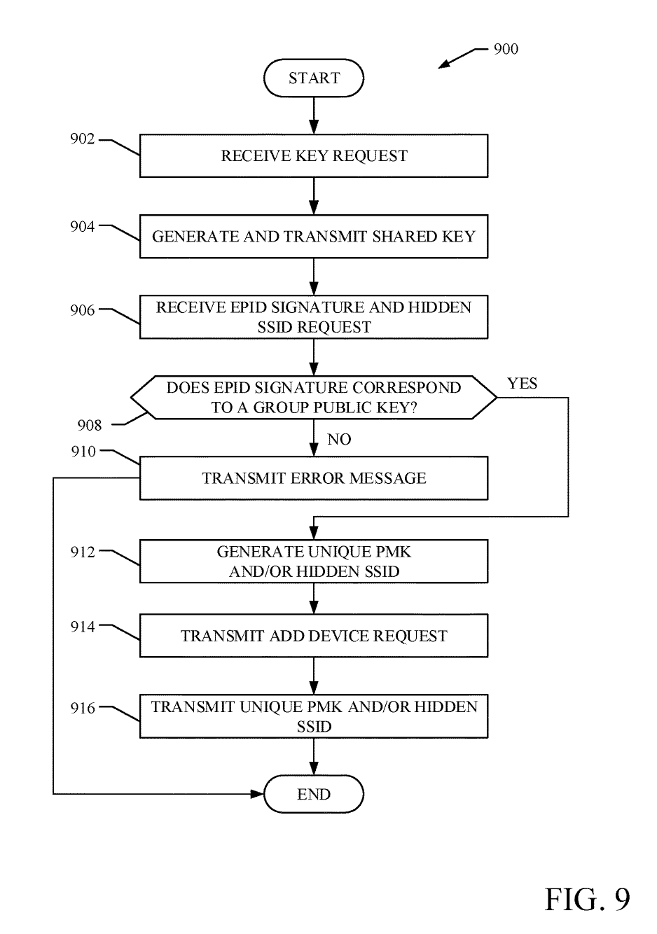

The example EPID verifier server 116 authenticates the example client device 102 based on an EPID associated with the example client device 102. The EPID verifier server 116 receives an EPID signature from the example client device 102 (e.g., based on a Sigma key exchange). The example EPID verifier server 116 includes the example device authenticator 118. The example device authenticator 118 authenticates the example client device 102 by determining that the client device 102 belongs to a valid EPID group of EPID devices. In some examples, the device authenticator 118 determines when multiple requests have come from the same EPID group to access the example Wi-Fi AP 106 to prevent DoS attacks, as further described in FIGS. 6 and 9. An example authentication protocol associated with the example database 114 is illustrated in FIG. 4. An example authentication protocol associated with the example EPID verifier server 116 is illustrated in FIG. 5.

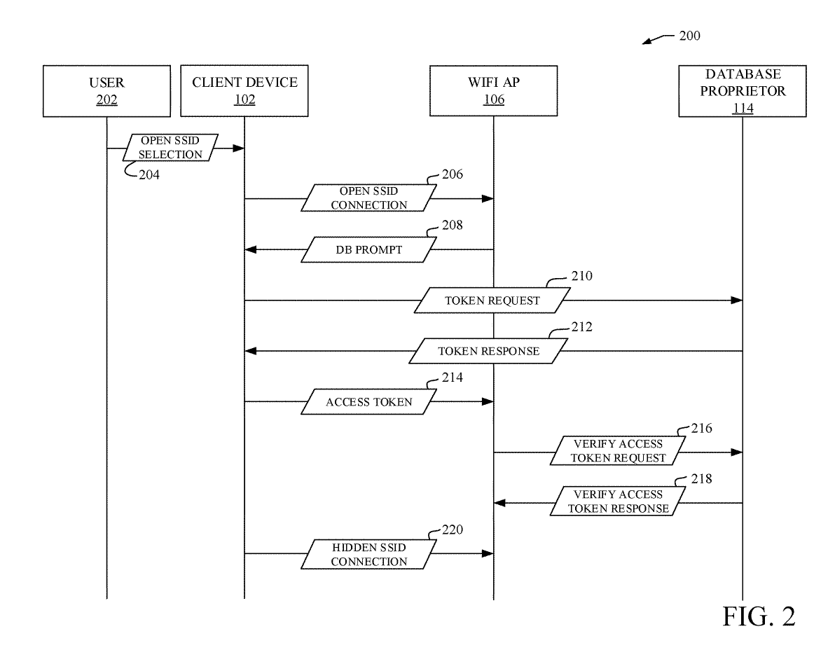

FIG. 2 is an example timing diagram 200 that illustrates an example of the communications between an example user 202, the example client device 102, the example Wi-Fi AP 106, and the example database proprietor 114 to provide a secure Wi-Fi connection to the example network 112 of FIG. 1. The example timing diagram 200 is described in conjunction with FIG. 1. Although the example timing diagram 200 illustrates a particular series of communications, any series of communications can be used to authenticate the example client device 102 using the example database proprietor 114. For example, the order of execution of the communication blocks may be changed, and/or some of the blocks described may be changed, eliminated, or combined. The example timing diagram 200 includes an example open SSID selection 204, an example open SSID connection 206, an example database proprietor prompt 208, an example token request 210, an example token response 212, an example access token 214, an example verify access token request 216, an example verify access token response 218, and an example hidden SSID connection 220.

The example Wi-Fi AP 106 advertises an open SSID to the example client device 102. The example timing diagram 200 begins when the example user 202 selects an open SSID on the example client device 102. The example open SSID selection 204 causes the example client device 102 to connect to the example Wi-Fi AP 106 via the example open SSID connection 206 (e.g., using the example communication link 110). Once the example communication link 110 is established, the example access granter 108 of the example Wi-Fi AP 106 adjusts a firewall associated with the Wi-Fi AP to open a connection between the example client device 102 and the example database proprietor 114. The example Wi-Fi AP 106 transmits the example database proprietor (DB) prompt 208 to the example client device 102. The example DP prompt 208 prompts the example user 202 to sign into the example database proprietor 114. In some examples, the example Wi-Fi AP 106 may prompt the user to log into one of many database proprietors. In some examples, the client device 102 automatically logs into the example database proprietor 114 in response to receiving the prompt.

Once the example user 202 signs into the example database proprietor 114 (e.g., is authenticated by the example database proprietor 114), the example client device 102 transmits the example token request 210 to the example database proprietor 114 via the example Wi-Fi AP 106. In some examples, the request includes an identifier (e.g., MAC address) of the client device 102. In response to receiving the example token request 210, the example database proprietor 114 transmits the example token response 212 to the example client device 102 via the example Wi-Fi AP 106. The example token response 212 includes a unique access token. In response to receiving the example access token 214, the example client device 102 transmits the example access token 214 to the example Wi-Fi AP 106. Additionally or alternatively, the example database proprietor 114 may transmit the access token to the example Wi-Fi AP 106. In some examples, the database proprietor 114 may include a Mac address, or other identifier, of the client device 102 to the example Wi-Fi AP 106 with the unique access token. In some examples, the client device 102 forwards the unique access token to the example Wi-Fi AP 106.

The example Wi-Fi AP 106 authenticates the example client device 102 by verifying that data from the example client device 102 matches data from the example database proprietor 114. In the example timing diagram 200, the example Wi-Fi AP 106 transmits the example verify access token request 216 with the received token from the example client device 102. In response to receiving the example verify access token request 216, the example database proprietor 114 transmits the example verify access token response 218 to the example Wi-Fi AP 106. If the example access token 214 is a valid access token, the example verify access token response 218 provides the Wo-Fi AP 106 verification that the example client device 102 is authentic. If the example access token 214 is not a valid access token, the example verify access token response 218 will be an error message indicating that the example client device 102 is not authentic. In some examples, such as when the example database proprietor 114 transmits the access token to the example Wi-Fi AP 106, the example verify access token request 216 and the example verify access token response 218 may be unnecessary because the Wi-Fi AP 106 can compare the access token from the example client device 102 and the access token from the database proprietor 114 directly.

If the verify access token response 218 does authenticate the example client device 102, the example access granter 108 adds the MAC address of the client device 102 to an allowed list. The allowed list is a list of devices that have full and secure access to the example network 112. In some examples, the access granter 108 opens a hidden SSID and encrypts the hidden SSID with a PMK. The PMK may be associated with a user ID, a service provider ID, the MAC address of the example client device 102, a MAC address of the example Wi-Fi AP 106, and/or the unique access token. In such examples, the client device 102 connects to the hidden SSID via the example hidden SSID connection 220 using the PMK. In some examples, the Wi-Fi AP 106 may credit the database proprietor 114 for granting the client device 102 access to the example network 112. Additionally, the example secure AP determiner 104 of the example client device 102 may determine, at any time, that the example Wi-Fi AP 106 is a rogue AP when the authentication protocol is not properly followed, as further described in FIGS. 4 and 7.

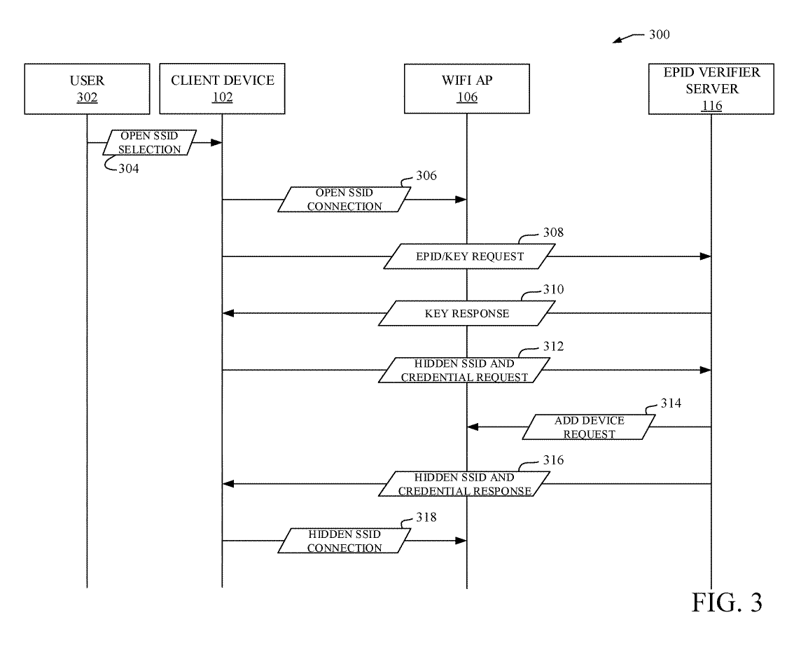

FIG. 3 is an example timing diagram 300 that illustrates an example of the communications between an example user 302, the example client device 102, the example Wi-Fi AP 106, and the example EPID verifier server 116 to provide a secure Wi-Fi connection to the example network 112 of FIG. 1. The example timing diagram 300 is described in conjunction with FIG. 1. Although the example timing diagram 300 illustrates a particular series of communications, any series of communications can be used to authenticate the example client device 102 using the example EPID verifier server 116. For example, the order of execution of the communication blocks may be changed, and/or some of the blocks described may be changed, eliminated, or combined. The example timing diagram 300 includes an example open SSID selection 304, an example open SSID connection 306, an example EPID/key request 308, an example key response 310, an example hidden SSID and credential request 312, an example add device request 314, an example hidden SSID and credential response 316, and an example Hidden SSID connection 318.

The example Wi-Fi AP 106 advertises an open SSID to the example client device 102. The example timing diagram 300 begins when the example user 302 selects the open SSID on the example client device 102. The example open SSID selection 304 causes the example client device 102 to connect to the example Wi-Fi AP 106 via the example open SSID connection 306. The example access granter 108 adjusts the firewall to open a connection between the example client device 102 and the example EPID verifier server 116. In some examples, the access granter 108 determines whether or not the client device 102 is associated with an EPID. In such examples, the access granter 108 may only adjust the firewall to open a connection to the example EPID verifier server 116 when the example client device 102 is associated with an EPID. In some example, the access granter 108 authenticates the client device using both the example database proprietor 114 and the EPID verifier server 116.

The example Wi-Fi AP 106 adjusts the firewall to allow the example client device 102 to transmit the example EPID/key request 308 to the example EPID verifier server 116 via the example Wi-Fi AP 106. The example EPID/key request 308 is an EPID-based Sigma key exchange request for a symmetric key to establish a secure connection between the example client device 102 and the example EPID verifier server 116 via the example Wi-Fi AP 106. The example EPID/key request 308 further includes an EPID-based signature used by the EPID verifier server 116 to determine that the example client device 102 belongs to a EPID group (e.g., authenticating the example client device 102). In some examples, the EPID/key request 308 is broken up into two or more requests to authenticate the example client device 102 and to establish a secure connection.

The example device authenticator 118 of the example EPID verifier server 116 verifies that the EPID of the example client device 102 belongs to a valid EPID group and transmits a response that a secure communication channel has been created between the example client device 102 and the example EPID verifier server 116. In some examples, the device authenticator 118 determines if a threshold number of requests have come from the same EPID group via the example Wi-Fi AP 106. In such examples, the device authenticator 118 may flag the client device 102 and/or artificially delay communications to prevent DoS attacks.

Once the example EPID verifier server 116 authenticates the example client device 102, the example EPID verifier server 116 transmits the example key response 310 to the example client device 102 via the example Wi-Fi AP 106. The example key response 310 includes a secure key used to establish a secure connection between the example client device 102 and the example EPID verifier server 116. Once the secure connection is established, the example client device 102 transmits the example hidden SSID and credential request 312 to the example EPID server 116 via the example Wi-Fi AP 106. In some examples, the hidden SSID and credential request includes an identifier (e.g., a MAC address) associated with the example client device 102. Once the example EPID verifier server 116 receives the example Hidden SSID and credential request 312, the example EPID verifier server 116 generates a hidden SSID ID and corresponding credentials (e.g., a PMK). The EPID verifier server 116 transmits the example add device request 314 to the example Wi-Fi AP 106. The example add device request 314 authenticates the example client device 102. In some examples, the add device request 314 may include the identifier associated with the example client device 102, the generated hidden SSID identifier, and/or the generated credentials. Additionally, the example EPID verifier server 116 transmits the example hidden SSID and credential response 316 including the generated hidden SSID ID and the credentials to the example client device 102 via the example Wi-Fi AP 106.

Once the example Wi-Fi AP 106 receives the example add device request 314, the example Wi-Fi AP 106 adds the device to the allowed list and opens a hidden SSID based on the received hidden SSID ID and credentials from the example EPID verifier server 116. The hidden SSID allows the example client device 102 to fully and securely access the example network 112 of FIG. 1. Once, the example Wi-Fi AP 106 opens the example hidden SSID, the example client device 102 established a connection via the example hidden SSID connection 318 using the received credentials. In some examples, the Wi-Fi AP 106 may credit the EPID verifier server 116 for granting the client device 102 access to the example network 112. Additionally, the example secure AP determiner 104 of the example client device 102 may determine, at any time, that the example Wi-Fi AP 106 is a rogue AP when authentication protocol is not properly followed.

FIG. 4 is a block diagram of an example implementation of the example secure AP determiner 104 of FIG. 1, disclosed herein, to determine if an AP is a secure AP (e.g., such as the example Wi-Fi AP 106 of FIG. 1) or a rogue AP. As previously described, a rogue AP is an unauthorized AP installed by an attacker. The example secure AP determiner 104 includes an example receiver 400, an example AP protocol determiner 402, an example AP protocol implementer 404, and an example transmitter 406.

The example receiver 400 wirelessly receives open SSID advertisements from the example Wi-Fi AP 106. Additionally, the example receiver 400 may receive data related to the Wi-Fi AP 106 including an identifier, a protocol identifier, and/or commands send from the example Wi-Fi AP 106. The commands may include a prompt to self-authenticate using the example database proprietor 114 (e.g., via the example Wi-Fi AP 106). In some examples, the receiver 400 receives data from the example database proprietor 114 (e.g., via the example Wi-Fi AP 106) including hidden SSIDs, PMKs, PSKs, unique access tokens, etc.

The example AP protocol determiner 402 determines an authentication protocol of the example Wi-Fi AP 106. The AP protocol determiner 402 may determine the authentication protocol based on data received directly from the example Wi-Fi AP 106. Additionally or alternatively, the example AP protocol determiner 402 may determine the authentication protocol based on the initial accessibility of the example client device 102. For example, if the AP protocol determiner 402 determines that the example Wi-Fi AP 106 is only granting access to the example database proprietor 114, then the example AP protocol determiner 402 may determine that the authentication protocol is associated with a database proprietor authentication. If the AP protocol determiner 402 determines that the example Wi-Fi AP 106 is only granting access to the example EPID verifier server 116, the example AP protocol determiner 402 may determine that the authentication protocol is associated with an EPID authentication. If the AP protocol determiner 402 determines that the Wi-Fi AP 106 is not associated with the database proprietor authentication and/or the EPID authentication, the example AP protocol determiner 402 may determine that the Wi-Fi AP 106 is an insecure or a rogue AP and may flag and/or terminate the connection. In some examples, the AP protocol determiner 402 may determine that the example Wi-Fi AP 106 is an insecure and/or a rogue AP, if the proper protocol is not followed. For example, if the example receiver 400 does not receive a request, token, etc. associated with an authentication protocol, the example AP protocol determiner 402 may determine that the Wi-Fi AP 106 is insecure. Additionally or alternatively, the example AP protocol determiner 402 may identify the flag to the user via a user interface associated with the example client device 102.

The example AP protocol implementer 404 follows the authentication protocol associated with the example Wi-Fi AP 106. For example, the AP protocol implementer 404 may transmit data (e.g., requests, tokens, identifiers, etc.) to the example Wi-Fi AP 106, the example database proprietor 114, and/or the example EPID verifier server 116 based on the protocol.

The example transmitter 406 transmits to the requests to connect to the example Wi-Fi AP 106. Additionally, the example transmitter 406 may transmit a token request to the example database proprietor 114 (e.g., via the example Wi-Fi AP 106) and relay a unique access token to the example Wi-Fi AP 106. In some examples, the transmitter 406 initiates an EPID-based Sigma key exchange with the example EPID verifier server 116 (e.g., via the example Wi-Fi AP 106). Additionally, the example transmitter 406 may transmit hidden SSID requests with credentials to the example EPID verifier server 116 (e.g., via the example Wi-Fi AP 106).

FIG. 5 is a block diagram of an example implementation of the example access granter 108 of FIG. 1, disclosed herein, to establish a secure Wi-Fi connection between the example client device 102 and the example network 112 of FIG. 1. The example access granter 108 includes an example receiver 500, an example credential comparator 502, an example firewall controller 504, and an example transmitter 506.

The example receiver 500 receives connection requests from the example client device 102. In some examples, the receiver 500 may receive a unique access token from the example client device 102. In such examples, the receiver 500 may additionally receive a verification from the example database proprietor 114 that the received unique access token is valid. In some examples, the receiver 500 may receive a unique access token from the example database proprietor 114. In some examples, the receiver 500 may receive add device requests with a hidden SSID and credentials from the example EPID verifier server 116. As previously described, the example EPID verifier server 116 may determine that DoS attacks may be occurring when more than a threshold number of requests associated with a particular EPID group is received from the same Wi-Fi AP 106. Thus, the example receiver 500 may receive instructions from the example EPID verifier server 116 to terminate or slow a connection with the example client device 102.

The example credential comparator 502 compares data from the example client device 102 and the example database proprietor 114 and/or the example EPID verifier server 116. In some examples, the credential comparator 502 compares the access tokens from the example client device 102 and the example EPID verifier server 116. If the access token from the example client device 102 corresponds to the access token from example EPID verifier server 116, the credential comparator 502 determines that the example client device 102 is authentic. If the tokens do not match, the example credential comparator 502 determines that the example client device 102 is not authentic and denies the example client device from accessing the example network 112 of FIG. 1. In some examples, the credential comparator 502 determines that the example client device 102 is authentic based on receiving an add device request from the example EPID verifier server 116. In some examples, the credential comparator 502 may also slow or terminate a connection with the example client device 102. Additionally, once the client device 102 is authenticated, the example credential comparator 502 adds an ID (e.g., such as a MAC address) associated with the client device 102 to an allowed list. As previously described, the allowed list indicates client devices that receive full and secure access to the example network 112. In some examples, the credential comparator 502 may credit the example EPID verifier server 116 and/or the example database proprietor 114 based on the authentication of the example client device 102 (e.g., for sponsored connectivity for paid Wi-Fi APs). In some examples, the credential comparator 502 opens a connection using a hidden SSID.

The example firewall controller 504 adjusts the firewall to control the example client device's access to the example network 112 of FIG. 1. For example, when the example client device 102 initially connects to an SSID advertised by the example Wi-Fi AP 106, the example firewall controller 504 adjusts the firewall to allow the client device 102 to only access the example database proprietor 114 and/or the example EPID verifier server 116. In some examples, the example firewall controller 504 adjusts the firewall to allow the client device 102 full and secure access to the example network 112 when the example client device 102 is authenticated. In some examples, the firewall controller 504 adjusts the firewall to deny the client device 102 access to the example network 112 when the example client device 102 is not authenticated.

The example transmitter 506 transmits an open SSID to the example client device 102. In some examples, the example transmitter 506 transmits a prompt to the example client device 102. As previously described, the prompt may include a login for a list of database proprietors that may be accessed to authenticate the example client device 102. In some examples, the transmitter 506 transmits a unique access token received from the example client device 102 to the example database proprietor 114 to verify that the unique access token is authentic.

FIG. 6 is a block diagram of an example implementation of the example device authenticator 118 of FIG. 1, disclosed herein, to authenticate the example client device 102 of FIG. 1. The example device authenticator 118 includes an example receiver 600, and example EPID group identifier 602, an example symmetric key generator 604, an example request generator 606, an example hidden SSID/PMK generator 608, and an example transmitter 608.

The example receiver 600 receives an EPID-based Sigma key exchange request from the example client device 102 via the example Wi-Fi AP 106. The EPID-based Sigma key exchange request may include a signature signed using a private key. In some examples, the receiver 600 receives a hidden SSID request from the example client device 102 via the example Wi-Fi AP 106. The example hidden SSID request may include the MAC address, or any other identifier, of the example client device 102.

The example EPID group identifier 602 verifies a received EPID signature using a group public key. If the example EPID group identifier 602 can verify the signature using a group public key, the EPID group identifier 602 determines that the client device 102 corresponds to a group associated with the group public key. Thus, the EPID group identifier 602 determines that the example client device 102 is authentic. If the example EPID group identifier 602 cannot verify the signature using a group public key, the example EPID group identifier 602 may flag the example client device 102 or send an error message to the example Wi-Fi AP 106. The error message may signify that the example EPID verifier server 116 could not verify/authenticate the example client device 102. Additionally, the example EPID group identifier 602 may determine that a DoS attack may be occurring at the example Wi-Fi AP 106. For example, if the EPID group identifier 602 determines that multiple (e.g., more than a threshold number of) EPID-based Sigma requests are received from the example Wi-Fi AP 106 corresponding to the same EPID group, the example EPID group identifier 602 may generate a signal to the example Wi-Fi AP 106 identifying a potential DoS attack.

The example symmetric key generator 604 generates a symmetric key to share with the example client device 102. The example client device 102 uses the symmetric key to create a secure channel to the example EPID verifier server 116 with confidentiality, integrity, and encryption.

The example request/response generator 606 generates a request to be sent to the example Wi-Fi AP 106. The request is an add device request. The request indicates that the example client device 102 is authentic and should be added to the allowed list of the example Wi-Fi AP 106. In some examples, the request includes a MAC address, or other identifier, of the example client device 102. Additionally, the example request/response generator 606 may generate a unique PMK and/or a hidden SSID. In some examples, the unique PMK and/or the hidden SSID are included in the request. In some examples, the request/response generator 606 generates a response. The response corresponds to the hidden SSID request from the example client device 102. The example response may include the hidden SSID and/or the unique PMK.

The example transmitter 608 transmits the generated symmetric key to the example client device 102 via the example Wi-Fi AP 106. In some examples, the example transmitter 608 transmits the add device request generated by the example request/response generator 606 to the example Wi-Fi AP 106. Additionally, the example transmitter 608 may transmit the hidden SSID response generated by the example request/response generator 606 to the example client device 102 via the example Wi-Fi AP 106. In some examples, the example transmitter 608 transmits the DoS signal and/or the error message generated by the example EPID group identifier 602 to the example Wi-Fi AP 106.

While example manners of implementing the example secure AP determiner 104 of FIG. 1 is illustrated in FIG. 4, the example access granter 108 of FIG. 1 is illustrated in FIG. 5, and the example device authenticator 118 of FIG. 1 is illustrated in FIG. 6, elements, processes and/or devices illustrated in FIGS. 4, 5, and 6 may be combined, divided, re-arranged, omitted, eliminated and/or implemented in any other way. Further, the example receiver 400, the example AP protocol determiner 402, the example AP protocol implementer 404, the example transmitter 406, and/or, more generally, the example secure AP determiner 104 of FIG. 4, and/or the example receiver 500, the example credential comparator 502, the example firewall controller 504, the example transmitter 506, and/or, more generally, the example access granter 108 of FIG. 5, and/or the example receiver 600, the example EPID group identifier 602, the example key generator 604, the example request/response generator 606, the example transmitter 608, and/or more generally, the example device authenticator 118 of FIG. 6 may be implemented by hardware, machine readable instructions, software, firmware and/or any combination of hardware, machine readable instructions, software and/or firmware. Thus, for example, any of the example receiver 400, the example AP protocol determiner 402, the example AP protocol implementer 404, the example transmitter 406, and/or, more generally, the example secure AP determiner 104 of FIG. 4, and/or the example receiver 500, the example credential comparator 502, the example firewall controller 504, the example transmitter 506, and/or, more generally, the example access granter 108 of FIG. 5, and/or the example receiver 600, the example EPID group identifier 602, the example key generator 604, the example request/response generator 606, the example transmitter 608, and/or more generally, the example device authenticator 118 of FIG. 6, could be implemented by analog and/or digital circuit(s), logic circuit(s), programmable processor(s), application specific integrated circuit(s) (ASIC(s)), programmable logic device(s) (PLD(s)) and/or field programmable logic device(s) (FPLD(s)). When reading any of the apparatus or system claims of this patent to cover a purely software and/or firmware implementation, at least one of the example receiver 400, the example AP protocol determiner 402, the example AP protocol implementer 404, the example transmitter 406, and/or, more generally, the example secure AP determiner 104 of FIG. 4, and/or the example receiver 500, the example credential comparator 502, the example firewall controller 504, the example transmitter 506, and/or, more generally, the example access granter 108 of FIG. 5, and/or the example receiver 600, the example EPID group identifier 602, the example key generator 604, the example request/response generator 606, the example transmitter 608, and/or more generally, the example device authenticator 118 of FIG. 6, is/are hereby expressly defined to include a tangible computer readable storage device or storage disk such as a memory, a digital versatile disk (DVD), a compact disk (CD), a Blu-ray disk, etc. storing the software and/or firmware. Further still, the example secure AP determiner 104 of FIG. 4, the example access granter 108 of FIG. 5 and/or the example device authenticator 118 of FIG. 6 includes elements, processes and/or devices in addition to, or instead of, those illustrated in FIGS. 7-9, and/or may include more than one of any or all of the illustrated elements, processes and devices.

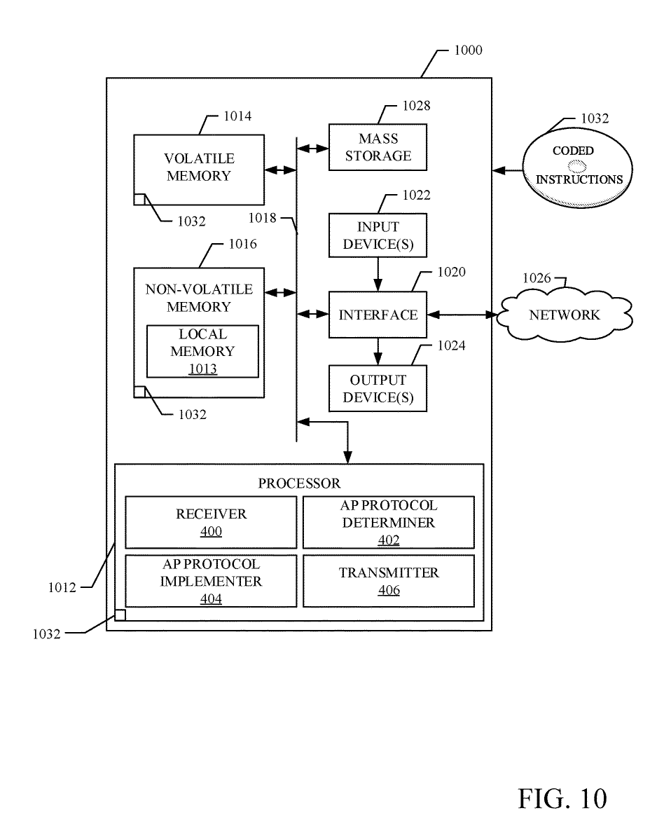

A flowchart representative of example machine readable instructions for implementing the example secure AP determiner 104 of FIG. 4 is shown in FIG. 7, the example access granter 108 of FIG. 5 is shown in FIGS. 8A and 8B, and the example device authenticator 118 of FIG. 6 is shown in FIG. 9. In the examples, the machine readable instructions comprise a program for execution by a processor such as the processors 1012, 1112, 1212 shown in the example processor platforms 1000, 1100, 1200 discussed below in connection with FIGS. 10-12. The program may be embodied in machine readable instructions stored on a tangible computer readable storage medium such as a CD-ROM, a floppy disk, a hard drive, a digital versatile disk (DVD), a Blu-ray disk, or a memory associated with the processors 1012, 1112, 1212 but the entire program and/or parts thereof could alternatively be executed by a device other than the processors 1012, 1112, 1212 and/or embodied in firmware or dedicated hardware. Further, although the example program is described with reference to the flowcharts illustrated in FIGS. 7-9, many other methods of implementing the example secure AP determiner 104 of FIG. 4, the example access granter 108 of FIG. 5, and/or the example device authenticator 118 of FIG. 6 may alternatively be used. For example, the order of execution of the blocks may be changed, and/or some of the blocks described may be changed, eliminated, or combined.

As mentioned above, the example processes of FIGS. 7-9 may be implemented using coded instructions (e.g., computer and/or machine readable instructions) stored on a tangible computer readable storage medium such as a hard disk drive, a flash memory, a read-only memory (ROM), a compact disk (CD), a digital versatile disk (DVD), a cache, a random-access memory (RAM) and/or any other storage device or storage disk in which information is stored for any duration (e.g., for extended time periods, permanently, for brief instances, for temporarily buffering, and/or for caching of the information). As used herein, the term tangible computer readable storage medium is expressly defined to include any type of computer readable storage device and/or storage disk and to exclude propagating signals and to exclude transmission media. As used herein, “tangible computer readable storage medium” and “tangible machine readable storage medium” are used interchangeably. Additionally or alternatively, the example processes of FIGS. 7-9 may be implemented using coded instructions (e.g., computer and/or machine readable instructions) stored on a non-transitory computer and/or machine readable medium such as a hard disk drive, a flash memory, a read-only memory, a compact disk, a digital versatile disk, a cache, a random-access memory and/or any other storage device or storage disk in which information is stored for any duration (e.g., for extended time periods, permanently, for brief instances, for temporarily buffering, and/or for caching of the information). As used herein, the term non-transitory computer readable medium is expressly defined to include any type of computer readable storage device and/or storage disk and to exclude propagating signals and to exclude transmission media. As used herein, when the phrase “at least” is used as the transition term in a preamble of a claim, it is open-ended in the same manner as the term “comprising” is open ended.

FIG. 7 is an example flowchart 700 representative of example machine readable instructions that may be executed by the example secure AP determiner 104 of FIG. 4 to determine whether the Wi-Fi AP 106 of FIG. 1 is a secure (e.g., authentic) AP.

At block 702, the example receiver 400 receives an advertisement to connect to an open SSID from the example Wi-Fi AP 106 of FIG. 1. At block 704, the example transmitter 406 transmits a request to connect to the Wi-Fi AP 106 via the open SSID. Once, the example secure AP determiner 104 connects to the example Wi-Fi AP 106, the example AP protocol determiner 402 determines an authentication protocol of the example Wi-Fi AP 106 based on data transmitted from the example Wi-Fi AP 106 (block 706). In some examples, the Wi-Fi AP 106 may transmit data to the example receiver 400 identifying a particular authentication protocol. The authentication protocol may be associated with the example database proprietor 114 and/or the example EPID verifier server 116. Alternatively, there may be no authentication protocol (e.g., the Wi-Fi AP 104 provides little or no security and/or is a rogue AP).

In some examples, the AP protocol determiner 402 may identify an authentication protocol based on the access to the example network 112. For example, the AP protocol determiner 402 may determine that the authentication protocol is associated with an EPID verifier server when the Wi-Fi AP 106 only allows the example client device 102 to access the example EPID verifier server 116. In some examples, the AP protocol determiner 402 may determine that the authentication protocol is associated with the database proprietor 114 based on receiving a prompt to authenticate the client device 102 through the example database proprietor 114.

At block 708, the example AP protocol determiner 402 determines if the example Wi-Fi AP 106 is a secure AP based on whether there is a valid authentication protocol (e.g., associated with the example database proprietor 114 and/or the example EPID verifier server 116). If there is a valid authentication protocol, the example AP protocol determiner 402 determines that the example Wi-Fi AP 106 is secure. If there is not a valid authentication protocol, the example AP protocol determiner 402 determines that the example Wi-Fi AP 106 is not secure. If the example AP protocol determiner 402 determines that the Wi-Fi AP 106 is not secure, the example AP protocol determiner 402 flags the Wi-Fi AP 106 (block 710). The flag may trigger an operation of the example client device 102. For example, a flag may trigger a warning message to a user of the client device 102, disconnecting from the example Wi-Fi AP 106, and/or transmitting the flag to another computing device.

If the example AP protocol determiner 402 determines that the example Wi-Fi AP 106 is a secure AP, the then the AP protocol implementer 404 performs a series of operations to run the authentication protocol (block 712). At block 714, the AP protocol implementer 404 determines if there was an unexpected operation while performing the authentication protocol. For example, a rogue AP may attempt to operate like a valid AP in order to gather data from the example client device 402 by self-identifying as a secure AP associated with an authentication protocol without actually performing the operations associated with the authentication protocol. In such an example, the AP protocol implementer 404 may determine that the authentication protocol was not properly followed (e.g., an unexpected operation occurred or an expected operation did not occur). For example, the example receiver 400 should receive a response to an EPID Sigma key exchange request. Thus, if the example transmitter 406 transmits the EPID Sigma key exchange request and does not receive the EPID response, the AP protocol implementer 404 may determine that the Wi-Fi AP 106 is not secure and flag the Wi-Fi AP 106. If the AP protocol implementer 404 determines that an unexpected operation did occur, the AP protocol implementer 404 may flag the Wi-Fi AP 106 (block 710).

FIG. 8A is an example flowchart 800 representative of example machine readable instructions that may be executed by the example access granter 108 of FIG. 5 to provide the example client device 102 with a secure link to access the example network 112 of FIG. 1 via an authentication protocol associated with the example database proprietor 114 and/or the example EPID verifier server 116.

At block 802, the example receiver 500 receives a connection request from the example client device 102 of FIG. 1. At block 804, the example credential comparator 502 determines if the example client device is on the allowed list. As previously described, the allowed list is associated with authenticated devices that are permitted full and secure access to the example network 112 of FIG. 1. In some examples, the example credential comparator 502 determines if the client device 102 is on the allowed list based on a MAC address, or other identifier, of the example client device 102. If the example credential comparator 502 determines that the client device 102 is on the allowed list, the process continues to block 818.

If the example credential comparator 502 determines that the client device 102 is not on the allowed list, the example credential comparator 502 determines if the client device is associated with an EPID (block 806). In some examples, the credential comparator 502 determines that the client device is associated with an EPID-based on data received from the example client device 102. Alternatively, the example credential comparator 502 may initially assume that the client device is associated with an EPID and later determine that the client device is not associated with an EPID when, for example, the client device does not follow the authentication protocol associated with the example EPID verifier server 116. If the example credential comparator 502 determines that the client device 102 is not associated with an EPID, the example credential comparator 502 authenticates the example client device 102 via the example database proprietor 114, as further shown in FIG. 8B. If the example credential comparator 502 determines that the client device 102 is associated with an EPID, the example firewall controller 504 adjusts a firewall of the example Wi-Fi AP 106 to only allow a connection to the example EPID verifier server 116 (block 808).

At block 810, the example receiver 500 receives data from the example EPID verifier server 116. The data may be an add device request including a MAC address or other identifier of the example client device 102, a hidden SSID identifier, and/or a unique PMK. Alternatively, the data may be an error message indicating that the example client device 112 is not a valid/authentic device. In some examples, the data from the example EPID verifier server 116 may indicate that a threshold number of requests have been received from the same EPID group (e.g., identifying a potential DoS attack). In such examples, the example credential comparator 502 may limit or deny access to the example client device 102.

At block 812, the example credential comparator 502 determines if the received data is an add device request. If the received data is not an add device request (e.g., the received data is an error message), the example firewall controller 504 adjusts the firewall to deny the example client device's 112 connection to the example network 112 (block 814). If the received data is an add device request, the example credential comparator 502 adds a MAC address, or other identifier, associated with the example client device 102 to the allowed list (block 816). Additionally, the credential comparator 502 may credit the example EPID verifier server 116 based on the authentication of the example client device 102 (e.g., for sponsored connectivity for paid Wi-Fi APs). In some examples, the credential comparator 502 may further authenticate the example client device 102 using the process of FIG. 8B before adding the example client device 102 to the allowed list.

At block 818, the example credential comparator 502 opens a hidden SSID with the received unique PMK. The hidden SSID is based on the received hidden SSID identifier and the unique PMK is based on the unique PMK from the example EPID verifier server 116. The example firewall controller 504 adjusts the firewall so that the client device 112 can have full and secure access to the example network 112 via the hidden SSID. In some examples, the credential comparator 502 may credit the EPID verifier server 116 based on the authentication of the example client device 102.

FIG. 8B is an example flowchart representative of example machine readable instructions that may be executed by the example access granter 108 of FIG. 5 to provide the example client device 102 with a secure link to access the example network 112 of FIG. 1 via an authentication protocol associated with the example database proprietor 114.

At block 820, the example firewall controller 504 adjusts the firewall of the example Wi-Fi AP 106 to only allow a connection to the example database proprietor 114. At block 822, the example transmitter 506 transmits a prompt to the example client device 102. As previously described, the prompt allows a user of the example client device 102 to authenticate the client device 102 by logging into the example database proprietor 114.

At block 824, the example receiver 500 receives data from the example client device 102. The client device data may be, for example, an access token. At block 826, the example receiver 500 receives data from the example database proprietor 114. The database proprietor data may be, for example, an access token and/or a MAC address or identifier of the example client device 102. In some examples, the transmitter 506 will transmit the received access token from the client device 102 to the example database proprietor 114. In such examples, the database proprietor data may be, for example, a verification that the access token from the client device 102 is valid.

At block 828, the example credential comparator 502 determines if the database proprietor data correspond to the client device data. For example, the credential comparator 502 may determine that the access token from the example client device 102 matches the access token from the example database proprietor 114. Alternatively, the example credential comparator 502 may determine that the database proprietor data corresponds to the client device data based on the verification from the example database proprietor 114, as previously described in FIG. 2. If the database proprietor data does not correspond to the client device data, the example firewall controller 504 adjusts the firewall of the example Wi-Fi AP 106 to deny the example client device 102 access to the example network 112 (block 830). If the database proprietor data does correspond to the client device data, the example credential comparator 502 adds the MAC address, or other identifier, associated with the example client device 102 to the allowed list (block 832). Additionally, the credential comparator 502 may credit the example database proprietor 114 based on the authentication of the example client device 102 (e.g., for sponsored connectivity for paid Wi-Fi APs).

At block 834, the example firewall controller 504 adjusts the firewall to allow the example client device 102 to fully and securely access the example network 112. Additionally or alternatively, the example credential comparator 502 may open a hidden SSID and encrypt the hidden SSID connection using a PMK (block 840). The PMK may be based on, for example, the access token, a user ID, a database proprietor ID, a client device MAC address, and/or a Wi-Fi AP MAC address. The firewall controller 504 may adjust the firewall so that the client device 102 can access the example network 112 using the hidden SSID.

FIG. 9 is an example flowchart 900 representative of example machine readable instructions that may be executed by the example device authenticator 118 of FIG. 6 to authenticate the example client device 102 of FIG. 1.

At block 902, the example receiver 600 receives a key request from the example client device 102 via the example Wi-Fi AP 106. At block 904, the example symmetric key generator 604 generates a symmetric key and the example transmitter 608 transmits the symmetric key to the example client device 102 via the example Wi-Fi AP 106. The example client device 102 uses the symmetric key to create a secure (e.g., encrypted) channel to the example EPID verifier server with confidentiality.

At block 906, the example receives a signature and hidden SSID request from the example client device 102. The signature is a message that the example client device 102 signed using a private key. As previously described, the example EPID group identifier 602 verifies the EPID signature (e.g., the signed message) using a group public key to authenticate the example client device 102. At block 908, the example EPID group identifier 602 determines whether the EPID signature corresponds to a group public key. If the example EPID group identifier 602 determines that the EPID signature does not correspond to a group public key, the example EPID group identifier 602 cannot authenticate the example client device 102 and the example transmitter 608 transmits an error message to the example Wi-Fi AP 106 (block 910). If the example EPID group identifier 602 determines that the EPID signature does correspond to a group public key, the example request/response generator 606 generates a unique PMK and/or a hidden SSID identifier (block 912). In some examples, the EPID group identifier 602 may determine that a threshold number of requests for the example Wi-Fi AP 106 have been received from the same EPID group. In such examples, the EPID group identifier 602 may send a signal to the example Wi-Fi AP 106 identifying the multiple requests (e.g., signifying a potential DoS attack).

At block 914, the example transmitter 608 transmits an add device request to the example Wi-Fi AP 106. The add device request verifies that the example client device 102 is authentic. The add device request may include a MAC address, or other identifier, of the example client device 102, the hidden SSID identifier, and/or the unique PMK. At block 916, the example transmitter 608 transmits the unique PMK and/or the hidden SSID identifier to the example client device 102 via the example Wi-Fi AP 106. The hidden SSID will be open by the example Wi-Fi AP 106 with the unique PMK. Thus, the client device 102 may use the example hidden SSID identifier and the unique PMK to connect to the example Wi-Fi AP 106 via the hidden SSID.

FIG. 10 is a block diagram of an example processor platform 1000 capable of executing the instructions of FIG. 9 to implement the example device authenticator 108 of FIGS. 1 and 4. The processor platform 1000 can be, for example, a server, a personal computer, a mobile device (e.g., a cell phone, a smart phone, a tablet such as an iPad™), a personal digital assistant (PDA), an Internet appliance, or any other type of computing device.

The processor platform 1000 of the illustrated example includes a processor 1012. The processor 1012 of the illustrated example is hardware. For example, the processor 1012 can be implemented by integrated circuits, logic circuits, microprocessors or controllers from any desired family or manufacturer.

The processor 1012 of the illustrated example includes a local memory 1013 (e.g., a cache). The example processor 1012 of FIG. 10 executes the instructions of FIG. 7 to implement the example receiver 400, the example AP protocol implementer 404, the example AP protocol determiner 402, and/or the example transmitter 406 of FIG. 4 to implement the example secure AP determiner 104. The processor 1012 of the illustrated example is in communication with a main memory including a volatile memory 1014 and a non-volatile memory 1016 via a bus 1018. The volatile memory 1014 may be implemented by Synchronous Dynamic Random Access Memory (SDRAM), Dynamic Random Access Memory (DRAM), RAMBUS Dynamic Random Access Memory (RDRAM) and/or any other type of random access memory device. The non-volatile memory 1016 may be implemented by flash memory and/or any other desired type of memory device. Access to the main memory 1014, 1016 is controlled by a clock controller.

The processor platform 1000 of the illustrated example also includes an interface circuit 1020. The interface circuit 1020 may be implemented by any type of interface standard, such as an Ethernet interface, a universal serial bus (USB), and/or a PCI express interface.

In the illustrated example, one or more input devices 1022 are connected to the interface circuit 1020. The input device(s) 1022 permit(s) a user to enter data and commands into the processor 1012. The input device(s) can be implemented by, for example, a sensor, a microphone, a camera (still or video), a keyboard, a button, a mouse, a touchscreen, a track-pad, a trackball, isopoint and/or a voice recognition system.

One or more output devices 1024 are also connected to the interface circuit 1020 of the illustrated example. The output devices 1024 can be implemented, for example, by display devices (e.g., a light emitting diode (LED), an organic light emitting diode (OLED), a liquid crystal display, a cathode ray tube display (CRT), a touchscreen, a tactile output device, and/or speakers). The interface circuit 1020 of the illustrated example, thus, typically includes a graphics driver card, a graphics driver chip or a graphics driver processor.

The interface circuit 1020 of the illustrated example also includes a communication device such as a transmitter, a receiver, a transceiver, a modem and/or network interface card to facilitate exchange of data with external machines (e.g., computing devices of any kind) via a network 1026 (e.g., an Ethernet connection, a digital subscriber line (DSL), a telephone line, coaxial cable, a cellular telephone system, etc.).

The processor platform 1000 of the illustrated example also includes one or more mass storage devices 1028 for storing software and/or data. Examples of such mass storage devices 1028 include floppy disk drives, hard drive disks, compact disk drives, Blu-ray disk drives, RAID systems, and digital versatile disk (DVD) drives.

The coded instructions 1032 of FIG. 10 may be stored in the mass storage device 1028, in the volatile memory 1014, in the non-volatile memory 1016, and/or on a removable tangible computer readable storage medium such as a CD or DVD.

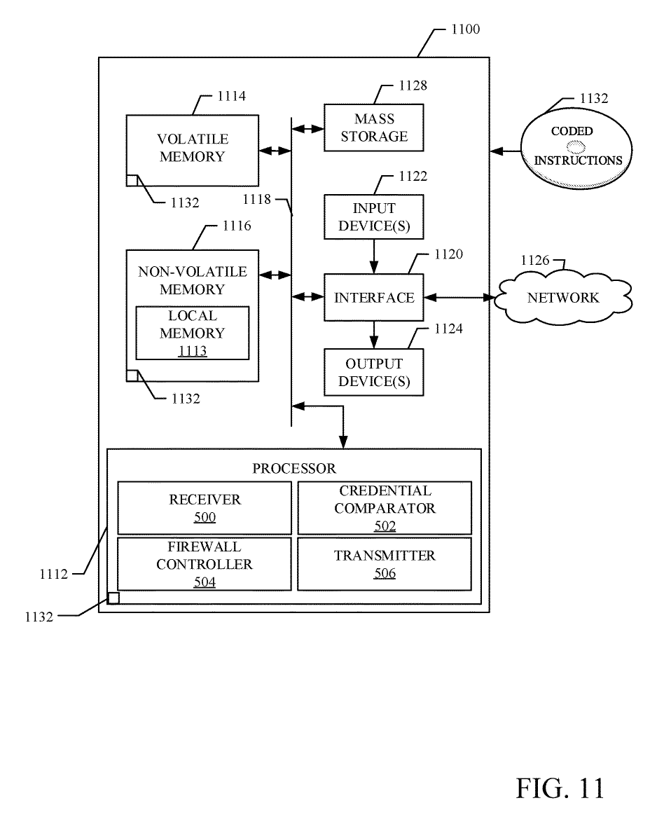

FIG. 11 is a block diagram of an example processor platform 1100 capable of executing the instructions of FIGS. 8A and 8B to implement the example access granter 108 of FIGS. 1 and 5. The processor platform 1100 can be, for example, a server, a personal computer, a mobile device (e.g., a cell phone, a smart phone, a tablet such as an iPad™), a personal digital assistant (PDA), an Internet appliance, or any other type of computing device.

The processor platform 1100 of the illustrated example includes a processor 1112. The processor 1112 of the illustrated example is hardware. For example, the processor 1112 can be implemented by integrated circuits, logic circuits, microprocessors or controllers from any desired family or manufacturer.

The processor 1112 of the illustrated example includes a local memory 1113 (e.g., a cache). The example processor 1112 of FIG. 11 executes the instructions of FIGS. 8A and 8B to implement the example receiver 500, the example credential comparator 502, the example firewall controller 504, and/or the example transmitter 506 to implement the example access granter 108. The processor 1112 of the illustrated example is in communication with a main memory including a volatile memory 1114 and a non-volatile memory 1116 via a bus 1118. The volatile memory 1114 may be implemented by Synchronous Dynamic Random Access Memory (SDRAM), Dynamic Random Access Memory (DRAM), RAMBUS Dynamic Random Access Memory (RDRAM) and/or any other type of random access memory device. The non-volatile memory 1116 may be implemented by flash memory and/or any other desired type of memory device. Access to the main memory 1114, 1116 is controlled by a clock controller.

The processor platform 1100 of the illustrated example also includes an interface circuit 1120. The interface circuit 1120 may be implemented by any type of interface standard, such as an Ethernet interface, a universal serial bus (USB), and/or a PCI express interface.

In the illustrated example, one or more input devices 1122 are connected to the interface circuit 1120. The input device(s) 1122 permit(s) a user to enter data and commands into the processor 1112. The input device(s) can be implemented by, for example, a sensor, a microphone, a camera (still or video), a keyboard, a button, a mouse, a touchscreen, a track-pad, a trackball, isopoint and/or a voice recognition system.

One or more output devices 1124 are also connected to the interface circuit 1120 of the illustrated example. The output devices 1124 can be implemented, for example, by display devices (e.g., a light emitting diode (LED), an organic light emitting diode (OLED), a liquid crystal display, a cathode ray tube display (CRT), a touchscreen, a tactile output device, and/or speakers). The interface circuit 1120 of the illustrated example, thus, typically includes a graphics driver card, a graphics driver chip or a graphics driver processor.

The interface circuit 1120 of the illustrated example also includes a communication device such as a transmitter, a receiver, a transceiver, a modem and/or network interface card to facilitate exchange of data with external machines (e.g., computing devices of any kind) via a network 1126 (e.g., an Ethernet connection, a digital subscriber line (DSL), a telephone line, coaxial cable, a cellular telephone system, etc.).

The processor platform 1100 of the illustrated example also includes one or more mass storage devices 1128 for storing software and/or data. Examples of such mass storage devices 1128 include floppy disk drives, hard drive disks, compact disk drives, Blu-ray disk drives, RAID systems, and digital versatile disk (DVD) drives.

The coded instructions 1132 of FIG. 11 may be stored in the mass storage device 1128, in the volatile memory 1114, in the non-volatile memory 1116, and/or on a removable tangible computer readable storage medium such as a CD or DVD.

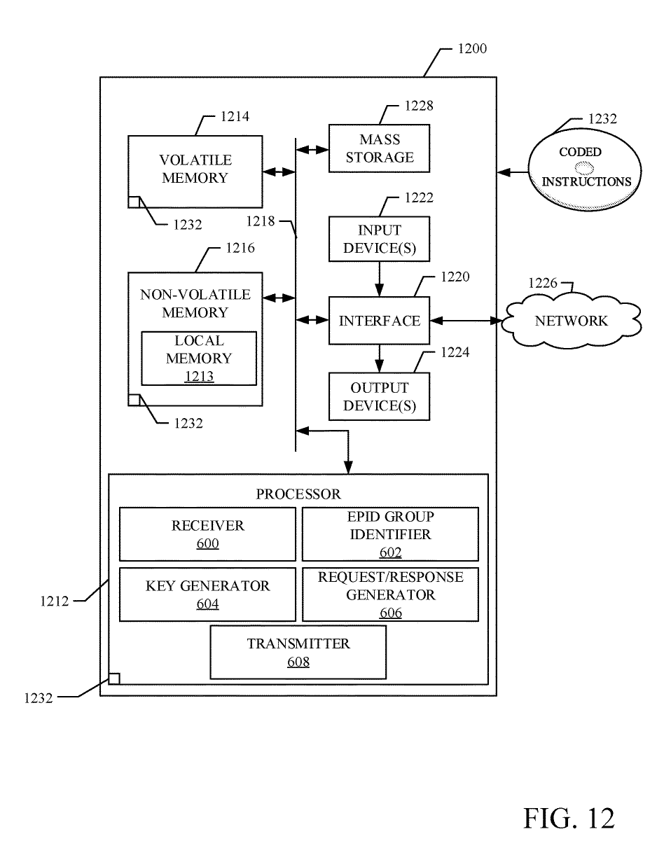

FIG. 12 is a block diagram of an example processor platform 1200 capable of executing the instructions of FIG. 9 to implement the example device authenticator 118 of FIGS. 1 and 6. The processor platform 1200 can be, for example, a server, a personal computer, a mobile device (e.g., a cell phone, a smart phone, a tablet such as an iPad™), a personal digital assistant (PDA), an Internet appliance, or any other type of computing device.

The processor platform 1200 of the illustrated example includes a processor 1212. The processor 1212 of the illustrated example is hardware. For example, the processor 1212 can be implemented by integrated circuits, logic circuits, microprocessors or controllers from any desired family or manufacturer.

The processor 1212 of the illustrated example includes a local memory 1213 (e.g., a cache). The example processor 1212 of FIG. 12 executes the instructions of FIG. 9 to implement the example receiver 600, the example EPID group identifier 602, the example key generator 604, the example request/response generator 606, and/or the example transmitter 608 to implement the example device authenticator 118. The processor 1212 of the illustrated example is in communication with a main memory including a volatile memory 1214 and a non-volatile memory 1216 via a bus 1218. The volatile memory 1214 may be implemented by Synchronous Dynamic Random Access Memory (SDRAM), Dynamic Random Access Memory (DRAM), RAMBUS Dynamic Random Access Memory (RDRAM) and/or any other type of random access memory device. The non-volatile memory 1216 may be implemented by flash memory and/or any other desired type of memory device. Access to the main memory 1214, 1216 is controlled by a clock controller.

The processor platform 1200 of the illustrated example also includes an interface circuit 1220. The interface circuit 1220 may be implemented by any type of interface standard, such as an Ethernet interface, a universal serial bus (USB), and/or a PCI express interface.

In the illustrated example, one or more input devices 1222 are connected to the interface circuit 1220. The input device(s) 1222 permit(s) a user to enter data and commands into the processor 1212. The input device(s) can be implemented by, for example, a sensor, a microphone, a camera (still or video), a keyboard, a button, a mouse, a touchscreen, a track-pad, a trackball, isopoint and/or a voice recognition system.

One or more output devices 1224 are also connected to the interface circuit 1220 of the illustrated example. The output devices 1224 can be implemented, for example, by display devices (e.g., a light emitting diode (LED), an organic light emitting diode (OLED), a liquid crystal display, a cathode ray tube display (CRT), a touchscreen, a tactile output device, and/or speakers). The interface circuit 1220 of the illustrated example, thus, typically includes a graphics driver card, a graphics driver chip or a graphics driver processor.

The interface circuit 1220 of the illustrated example also includes a communication device such as a transmitter, a receiver, a transceiver, a modem and/or network interface card to facilitate exchange of data with external machines (e.g., computing devices of any kind) via a network 1226 (e.g., an Ethernet connection, a digital subscriber line (DSL), a telephone line, coaxial cable, a cellular telephone system, etc.).

The processor platform 1200 of the illustrated example also includes one or more mass storage devices 1228 for storing software and/or data. Examples of such mass storage devices 1228 include floppy disk drives, hard drive disks, compact disk drives, Blu-ray disk drives, RAID systems, and digital versatile disk (DVD) drives.

The coded instructions 1232 of FIG. 12 may be stored in the mass storage device 1228, in the volatile memory 1214, in the non-volatile memory 1216, and/or on a removable tangible computer readable storage medium such as a CD or DVD.

From the foregoing, it would be appreciated that the above disclosed method, apparatus, and articles of manufacture provide secure communications between Wi-Fi enabled devices and open (e.g., free and/or sponsored) Wi-Fi APs. Using example disclosed herein, an open Wi-Fi AP authenticates a device through the use of a database proprietor and/or an EPID verifier server. In such examples, upon connection, the open Wi-Fi AP allows the device to only access the database proprietor and/or EPID verifier server. The database proprietor and/or EPID verifier server authenticates the device. Once the device is authenticated, the Wi-Fi AP allows full and secure access to a network (e.g., the Internet). In some examples, the Wi-Fi AP may establish secure access using a hidden SSID connection based on the authentication process. Examples disclosed herein prevent DoS and man-in-the-middle attacks by securing a confidential and encrypted connection in free and/or sponsored Wi-Fi AP environments.

A first conventional technique for establishing a connection to an open Wi-Fi AP includes using a public SSID as a PSK. In such a conventional technique, the PSK is publicly known. Thus, the connection is not confidential and the encryption is weak. A second technique for establishing a secure connection to an open Wi-Fi AP includes running a Diffie Hellman to generate a PMK. Such a conventional technique is also not confidential and does not prevent man-in-the-middle attacks. Examples disclosed herein alleviate such problems by using a database proprietor and/or an EPID verifier server to authenticate a client device and provide a unique (e.g., confidential) PMK to establish a secure connection to the open Wi-Fi AP.

Example 1 is a method comprising, in response to receiving a request from a computing device to connect to a network, limiting, with a processor of a Wi-Fi access point, access of the computing device to the network to connect to a server. Example 1 also includes authenticating, with the processor of the Wi-Fi access point, the computing device based on data received from the server. Example 1 also includes expanding, with the processor of the Wi-Fi access point, the access of the computing device to connect to the network.

Example 2 includes the subject matter of example 1, wherein the limiting of the access of the computing device to connect to the server includes adjusting a firewall of the Wi-Fi access point.

Example 3 includes the subject matter of examples 1 or 2, wherein the expanding of the access of the computing device to connect to the network includes adjusting a firewall of the Wi-Fi access point.

Example 4 includes the subject matter of example 1, wherein the server corresponds to at least one of a database proprietor or an enhanced privacy identifier (EPID) verifier.

Example 5 includes the subject matter of example 4, further including, when the server corresponds to the EPID verifier, receiving a request to add the computing device from the EPID verifier, the data being the request.

Example 6 includes the subject matter of example 5, wherein the request includes at least one of an identifier of the computing device, a media access control address of the computing device, a hidden service set identifier, or a pairwise master key.

Example 7 includes the subject matter of example 6, further including opening a hidden connection using the hidden service set identifier, the computing device connecting to the network using the hidden connection.

Example 8 includes the subject matter of example 4, further including, when the server corresponds to the database proprietor, receiving a token from the computing device. Example 8 also includes verifying the token, the authentication being based on the verification.

Example 9 includes the subject matter of example 8, wherein the verifying of the token includes transmitting data to the database proprietor, the data including the token and receiving a verification from the database proprietor, the verification verifying that the token is valid.

Example 10 includes the subject matter of example 8, further including opening a hidden connection using a hidden server set identifier using a pairwise master key, at least one of the hidden server identifier or the pairwise master key including at least one of a user identifier, a computing device identifier, a database proprietor identifier, a Wi-Fi AP identifier, or the token.

Example 11 includes the subject matter of examples 7, 9, or 10, further including transmitting a prompt to the computing device, the prompt prompting a user of the computing device to log into the database proprietor.

Example 12 includes an apparatus comprising a receiver to receive a request from a computing device to connect to a network. Example 12 also includes a firewall controller to limit access of the computing device to the network to connect to a server. Example 12 also includes a credential comparator to authenticate the computing device based on data received from the server. Example 12 also includes the firewall controller to expand the access of the computing device to connect to the network.

Example 13 includes the subject matter of example 12, further including a firewall, the firewall controller to limit the access the computing device by adjusting the firewall.

Example 14 includes the subject matter of example 13, wherein the firewall controller is to expand the access of the computing device by adjusting the firewall.

Example 15 includes the subject matter of example 12, wherein the server corresponds to at least one of a database proprietor or an enhanced privacy identifier (EPID) verifier.

Example 16 includes the subject matter of example 15, wherein, when the server corresponds to the EPID verifier, the receiver is to receive a request to add the computing device from the EPID verifier, the data being the request.

Example 17 includes the subject matter of example 16, wherein the request includes at least one of an identifier of the computing device, a media access control address of the computing device, a hidden service set identifier, or a pairwise master key.

Example 18 includes the subject matter of example 16, wherein the credential comparator is to open a hidden connection using the hidden service set identifier, the computing device connecting to the network using the hidden connection.

Example 19 includes the subject matter of example 15, wherein, when the server corresponds to the database proprietor, the receiver is to receive a token from the computing device and the credential comparator is to verify the token, the authentication being based on the verification.

Example 20 includes the subject matter of example 19, further including a transmitter to transmit data to the database proprietor, the data including the token.

Example 21 includes the subject matter of example 20, wherein the receiver is to receive a verification from the database proprietor, the verification verifying that the token is valid.

Example 22 includes the subject matter of example 19, wherein the credential comparator is to open a hidden connection using a hidden server set identifier using a pairwise master key, at least one of the hidden server identifier or the pairwise master key including at least one of a user identifier, a computing device identifier, a database proprietor identifier, a Wi-Fi AP identifier, or the token.

Example 23 includes the subject matter of examples 18, 21, or 22, further including a transmitter to transmit a prompt to the computing device, the prompt prompting a user of the computing device to log into the database proprietor.

Example 24 includes a computer readable medium comprising instruction that, when executed, cause a machine to, in response to receiving a request from a computing device to connect to a network, limit access of the computing device to the network to connect to a server, authenticate the computing device based on data received from the server, and expand the access of the computing device to connect to the network.

Example 25 includes the subject matter of example 24, wherein the limiting of the access of the computing device to connect to the server includes adjusting a firewall of the Wi-Fi access point.

Example 26 includes the subject matter of examples 24 or 25, wherein the expanding of the access of the computing device to connect to the network includes adjusting a firewall of the Wi-Fi access point.

Example 27 includes the subject matter of example 24, wherein the server corresponds to at least one of a database proprietor or an enhanced privacy identifier (EPID) verifier.

Example 28 includes the subject matter of example 25, wherein the instruction case the machine to, when the server corresponds to the EPID verifier, receive a request to add the computing device from the EPID verifier, the data being the request.

Example 29 includes the subject matter of example 28, wherein the request includes at least one of an identifier of the computing device, a media access control address of the computing device, a hidden service set identifier, or a pairwise master key.

Example 30 includes the subject matter of example 29, wherein the instructions cause the machine to open a hidden connection using the hidden service set identifier, the computing device connecting to the network using the hidden connection.

Example 31 includes the subject matter of example 27, wherein the instructions cause the machine to, when the server corresponds to the database proprietor, receive a token from the computing device, and verify the token, the authentication being based on the verification.

Example 32 includes the subject matter of example 31, wherein the instructions cause the machine to transmit data to the database proprietor, the data including the token, and receive a verification from the database proprietor, the verification verifying that the token is valid.

Example 33 includes the subject matter of example 31, wherein the instructions cause the machine to open a hidden connection using a hidden server set identifier using a pairwise master key, at least one of the hidden server identifier or the pairwise master key including at least one of a user identifier, a computing device identifier, a database proprietor identifier, a Wi-Fi AP identifier, or the token.

Example 34 includes the subject matter of examples 30, 32, or 33, wherein the instructions cause the machine to transmit a prompt to the computing device, the prompt prompting a user of the computing device to log into the database proprietor.

Although certain example methods, apparatus and articles of manufacture have been described herein, the scope of coverage of this patent is not limited thereto. On the contrary, this patent covers all methods, apparatus and articles of manufacture fairly falling within the scope of the claims of this patent.

What is claimed is:

1. A method comprising:
in response to receiving a request from a computing device to connect to a network, limiting, with a processor of a Wi-Fi access point, access of the computing device to the network to connect to a server;
authenticating, with the processor of the Wi-Fi access point, the computing device based on data received from the server; and
expanding, with the processor of the Wi-Fi access point, the access of the computing device to connect to the network.

2. The method of claim 1, wherein the limiting of the access of the computing device to connect to the server includes adjusting a firewall of the Wi-Fi access point.

3. The method of claim 1, wherein the expanding of the access of the computing device to connect to the network includes adjusting a firewall of the Wi-Fi access point.

4. The method of claim 1, wherein the server corresponds to at least one of a database proprietor or an enhanced privacy identifier (EPID) verifier.

5. The method of claim 4, further including, when the server corresponds to the EPID verifier, receiving a request to add the computing device from the EPID verifier, the data being the request.

6. The method of claim 5, wherein the request includes at least one of an identifier of the computing device, a media access control address of the computing device, a hidden service set identifier, or a pairwise master key.

7. The method of claim 6, further including opening a hidden connection using the hidden service set identifier, the computing device connecting to the network using the hidden connection.

8. The method of claim 4, further including, when the server corresponds to the database proprietor:
receiving a token from the computing device; and
verifying the token, the authentication being based on the verification.

9. The method of claim 8, wherein the verifying of the token includes:
transmitting data to the database proprietor, the data including the token; and
receiving a verification from the database proprietor, the verification verifying that the token is valid.

10. The method of claim 8, further including opening a hidden connection using a hidden server set identifier using a pairwise master key, at least one of the hidden server identifier or the pairwise master key including at least one of a user identifier, a computing device identifier, a database proprietor identifier, a Wi-Fi AP identifier, or the token.

11. The method of claim 4, further including transmitting a prompt to the computing device, the prompt prompting a user of the computing device to log into the database proprietor.

12. An apparatus comprising:
a receiver to receive a request from a computing device to connect to a network;
a firewall controller to limit access of the computing device to the network to connect to a server;
a credential comparator to authenticate the computing device based on data received from the server; and
the firewall controller to expand the access of the computing device to connect to the network.

13. The apparatus of claim 12, further including a firewall, the firewall controller to limit the access the computing device by adjusting the firewall.

14. The apparatus of claim 13, wherein the firewall controller is to expand the access of the computing device by adjusting the firewall.

15. The apparatus of claim 12, wherein the server corresponds to at least one of a database proprietor or an enhanced privacy identifier (EPID) verifier.

16. The apparatus of claim 15, wherein, when the server corresponds to the EPID verifier, the receiver is to receive a request to add the computing device from the EPID verifier, the data being the request.

17. The apparatus of claim 15, wherein, when the server corresponds to the database proprietor:
the receiver is to receive a token from the computing device; and
the credential comparator is to verify the token, the authentication being based on the verification.

18. The apparatus of claim 15, further including a transmitter to transmit a prompt to the computing device, the prompt prompting a user of the computing device to log into the database proprietor.

19. A computer readable medium comprising instruction that, when executed, cause a machine to:
in response to receiving a request from a computing device to connect to a network, limit access of the computing device to the network to connect to a server;
authenticate the computing device based on data received from the server; and
expand the access of the computing device to connect to the network.

20. The computer readable medium of claim 24, wherein the server corresponds to at least one of a database proprietor or an enhanced privacy identifier (EPID) verifier.
